(19) United States
(12) Patent Application Publication
(10) Pub. No.: US 2008/0257279 A1
(43) Pub. Date: Oct. 23, 2008

(54) Device for handling reptiles

(76) Inventor: Judith Yvonne Jezl, League City, TX (US)

Correspondence Address: THE MATTHEWS FIRM, 2000 BERING DRIVE, SUITE 700, HOUSTON, TX, 77057, US

(21) Appl. No.: 12/214,326

(22) Filed: Jun. 18, 2008

Related U.S. Application Data
(63) Continuation-in-part of application No. 11/161,197, filed on Jul. 26, 2005, now abandoned.
(60) Provisional application No. 60/591,733, filed on Jul. 28, 2004.

(51) Int. Cl. A01K 15/04

(52) U.S. Cl. 119/801

(57) ABSTRACT

A lightweight snake hook includes a hook portion attached to a distal end of a shaft portion. The shaft portion can be a hollow rod of aluminum or fiberglass, and an end of the hook portion can be attached to the hollow end with an epoxy. The hook portion has a profile, such as U-shaped, “recurve,” S-shaped, or rectilinear whereby the profile is substantially congruent with the snake, for supporting the snake. The hook portion is formed from a substantially cylindrical rod of polycarbonate or like material bent into the profile and having a thermal conductivity less than about 4 W/(m·K). The polycarbonate hook portion is lightweight and strong and allows a handler to use the hook on long shafts and with large bodied snakes. Furthermore, the hook portion has a diameter providing a broad base or resting area for the snake. For example, the broad base is beneficial for snakes having delicate ribs, such as the Gaboon Viper.

### CROSS-REFERENCE TO RELATED APPLICATIONS

This application is a Continuation-in-Part of and claims priority to U.S. patent application Ser. No. 11/161,197 (filed on Jul. 26, 2005), which claims the benefit of U.S. Provisional Application Ser. No. 60/591,733 (filed Jul. 28, 2004), both of which are incorporated herein by reference.

### FIELD OF THE INVENTION

The subject matter of the present disclosure generally relates to a device for handling reptiles and more particularly relates to a strong, lightweight hook for handling various snakes including large snakes and venomous snakes.

### BACKGROUND OF THE INVENTION

Referring to FIGS. 1A-1B, a snake hook 10 according to the prior art is illustrated. The snake hook 10 includes a hook portion 12 and a shaft portion 14. The snake hook 10 is similar to other hooks commercially available. The hook portion 12 is made from a solid, aluminum rod, which is aircraft grade and may or may not be anodized. The hook portion 12 is inserted into the end 15 of the shaft 14, which is hollow. The diameter or thickness 16 of the hook portion 12 can be about 3/16-inch or ⅜-inch. For larger snake hooks, the jaw opening 18 of the hook can be about 3.5-inches wide at the end. For smaller hooks, for example, the jaw opening 18 can be about 1.5-inches. The shaft portion 14 is made with stainless steel and may be a slightly flexible. The shaft can be from 16 to 24-inches long.

Some embodiments of snake hooks in the prior art include integral hook and shaft portions 12, 14 that are made from 3/16 inch metal rod. One such integral snake hook is available from Tomahawk Live Trap and is about 47 inches in length. Animal Care Equipment & Services, Inc. similarly has an integral rod snake hook that is about 4-ft. long and has a jaw opening of about 2-inches. The longer snake hooks with wider jaw openings are recommended for restraining and lifting large, heavy-bodied snakes, such as constrictors or pythons.

Referring to FIGS. 2A-2B, another snake hook 20 according to the prior art is illustrated. The snake hook 20 includes a hook portion 22 attached at a distal end 25 of a shaft portion 24. The snake hook 20 is similar to hooks available from Snakesticks.com, Inc. of Miami, Fla. The snake hook 20 can be used for handling heavy-bodied or venomous snakes. The hook portion 22 is made from stainless steel, although aluminum is also used. The hook portion 22 is flat and has a width 27 of about 1.25-inch and a thickness 26 of about 3/16-inch. The hook portion 22 can have a jaw opening of about 2 to 3-inches. The shaft portion 22 is extendable and is made from fiberglass and aluminum shaft. The shaft portion 24 can be extended from about 31-inches to about 50-inches.

The larger snake hooks are used to handle large body snakes, such as boa constrictors, pythons, etc. However, aluminum hook portions are not typically intended for supporting heavy-bodied snakes, and steel or titanium is used instead. When handling large snakes, handlers may use two larger snake hooks at the same time to pick up and move the snake. Because neonate or newborn snakes can still be venomous, use of a hook is still beneficial in handling these snakes. When used on neonates, however, the metal hooks known in the art can puncture the skin of the snake or can crush these snakes. By way of example, boa constrictors in captivity can exceed a weight of 60 pounds but usually they will not exceed 30 pounds as adults. Boa constrictors can be a length of about 6 to 10-ft. Pythons, such as an Indian python, can be about 12-ft. in length. A typical adult Indian python weighs between 70-120 pounds. The Burmese variety of python tends to be longer and heavier.

One large body venomous snake is the Gaboon Viper, which lives on the rain forest floor in the equatorial belt of Tropical Africa. The Gaboon Viper is poisonous and deadly, and its venomous bite can kill a human within 15 minutes. Gaboon Vipers can reach an average length of 1.2 meters, but they have been found as long as 2.2 meters. These animals will weigh about 7 to 10 kg. The average size of an adult is about 4 to 5 feet, being the largest viper in Africa attaining weights of over 20 kg.

When handling a larger body venomous snake, the snake hook is preferably long. Furthermore, two snake hooks are preferably used. Therefore, it is important that the hook is strong but lightweight, because the snake may itself be heavy and the ability to lift and move the snake is made more difficult by the longer length of the snake hook. In addition, the Gaboon Viper has substantially delicate ribs, which can be separated by about ¼-inches. When the Viper rests on the thin hook, the underside of the snake's body folds in a V-shape over the hook. Because of the small area of the thin hook when the snake folds over the hook, the weight of the snake will cause the vertebrae or rib to break at the point it folds on the metal hook. Thus, using conventional snake hooks formed from thin rods or flat metal plates may harm the Gaboon Viper. Furthermore, a Gaboon Viper that rests uncomfortably on a thin metal hook of the prior art will be harder to handle as the snake attempts to remove itself onto the shaft portion, which is undesirable for the handler. Therefore, a need exists for a strong and lightweight snake hook that has a broader base can be used with large venomous snakes, such as the Gaboon Viper, without injuring the vertebrae or ribs of the snake. In addition, a need exists for a strong and lightweight snake hook that is easier to handle and makes the lightweight hook more useful than the heavier metal counterparts explained above.

The subject matter of the present disclosure is directed to overcoming, or at least reducing the effects of, one or more of the problems set forth above.

### SUMMARY OF THE DISCLOSURE

This disclosure relates to a polycarbonate hook for handling snakes, which provides improved safety to both the snake being handled and to the individual handling the snake. A lightweight snake hook for handling a snake includes a shaft portion and a hook portion. The hook portion is attached to a distal end of the shaft portion. In one embodiment, for example, the shaft portion can be a hollow rod of aluminum or fiberglass, and an end of the hook portion can be attached to the hollow end with an epoxy. The hook portion has a profile for supporting the snake. The profile can be U-shaped or a ‘recurve,” S-shaped, or rectilinear. The hook portion is formed from a substantially cylindrical rod of polycarbonate bent into the profile. Preferably, solid Lexan™ polycarbonate from GE is used. The substantially cylindrical rod of polycarbonate has a diameter of about 0.5 to 1-inch. The hook portion has a jaw opening of approximately 0.5 to 3.5-inches. The polycarbonate hook portion is lightweight and strong and allows a handler to use the hook on long shafts and with large bodied snakes without adding substantial weight. Particularly indoors, cold-blooded snakes are prone to “jump” off prior art hooks or to slide up the shaft of the device towards a handler because they are uncomfortable on the cold metal hook. The polycarbonate hook provided herein has a thermal conductivity within a specific range providing a more natural “feel” to the snake. As such, the snake is inclined to wrap around the polycarbonate hook, like it would wrap around a tree branch, as opposed to sliding up the hook or attempting to jump off the hook. It can be seen when dealing with a large or venomous snake, the handlers safety is greatly increased when the snake rests comfortably on the end of the hook as opposed to sliding towards the handler or otherwise attempting to leave the hook.

The polycarbonate hook described herein provides several advantages to the wellbeing of the snake being handled. For instance, the hook portion can have a larger diameter providing a broad base or resting area for the snake without adding substantial weight to the snake hook. The broad base is beneficial for snakes having delicate ribs, such as the Gaboon Viper. Venomous neonates or smaller snakes are sometimes pinned or restrained so they can be handled safely. The polycarbonate hook, as well as other designs within the contemplated range of thermal conductivity, provides a softer or more forgiving surface for pinning neonates and smaller snakes. The increased elasticity of this material is strong enough to pin a snake down, but decreases the likelihood of injury to the snake. The polycarbonate hook described herein can be used to handle a number of reptiles such as smaller komodo dragons, crocodiles and alligators. These reptiles, including snakes, are less likely to shatter teeth or fangs on the plastic hook than on the convention metal hooks.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIGS. 1A-1B illustrate a snake hook according to the prior art.

FIGS. 2A-2B illustrate another snake hook according to the prior art.

FIGS. 3A-3B illustrate an embodiment of a snake hook according to certain teachings of the present invention.

FIGS. 4A-4B illustrate various embodiments of the disclosed snake hook.

FIG. 5 illustrates a handler with the disclosed snake hook moving a python.

FIG. 6 illustrates a Gaboon Viper supported on the disclosed snake hook.

FIG. 7 illustrates another embodiment of the snake hook according to certain teachings of the present invention.

FIG. 8 is a graph illustrating thermal properties of several materials as they relate to the snake hook of the present invention.

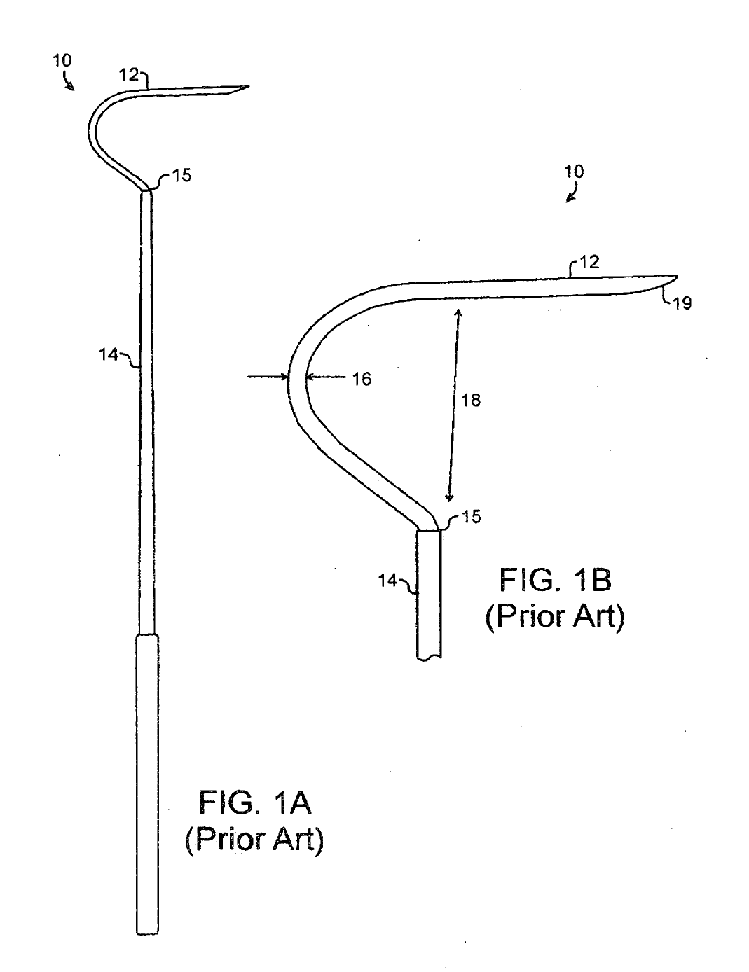

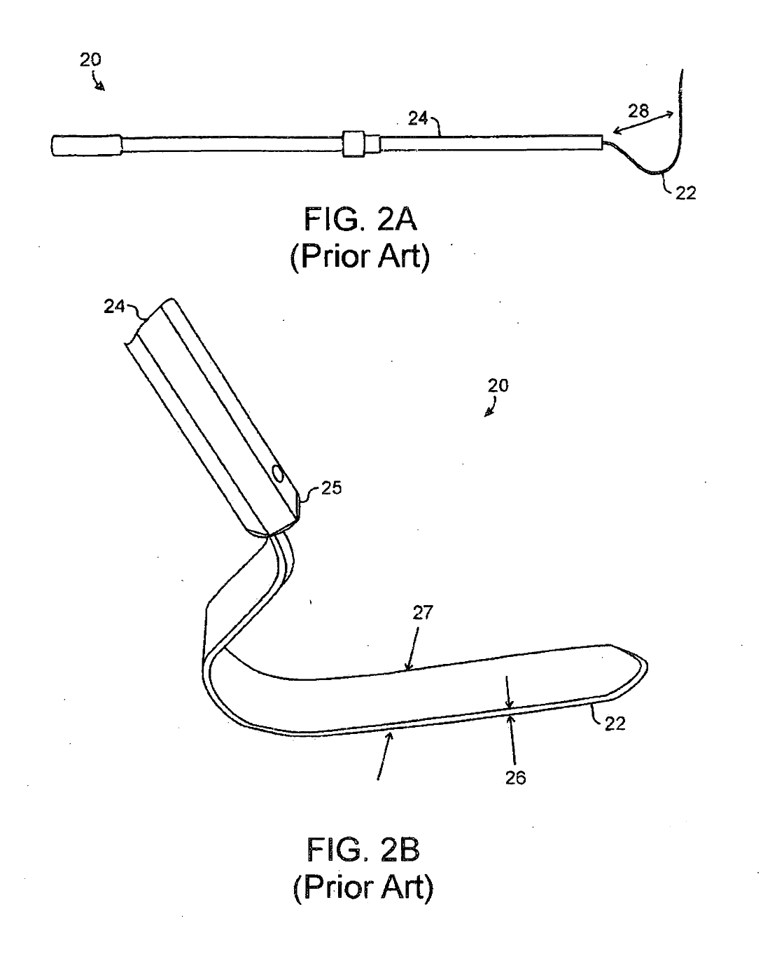

While the disclosed snake hook is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments.

### DETAILED DESCRIPTION

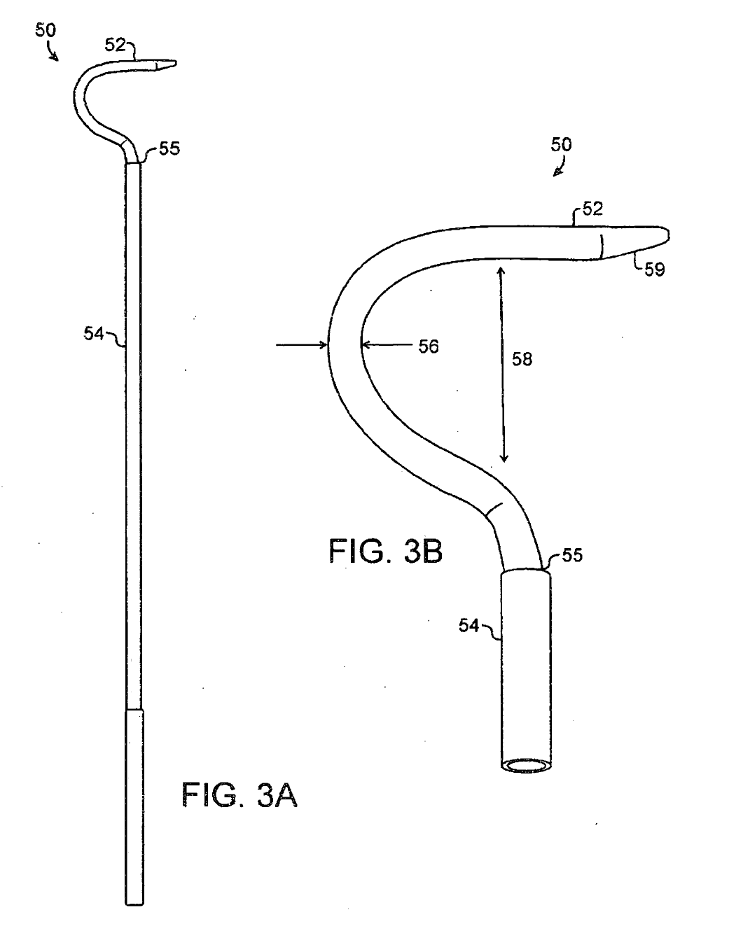

Referring to FIGS. 3A-3B, an embodiment of a snake hook 50 according to certain teachings of the present invention is illustrated. The snake hook 50 includes a hook portion 52 and a shaft portion 54. In the present embodiment, the hook portion 52 is formed into a profile having U-shape or “recurve.” Other profiles for the hook portion 52 include a V-shape or those disclosed below. The hook portion 52 is composed of a plastic material. Some plastic materials for the hook portion 52 can include thermoplastics, such as High Density Polyethylene (HDPE) and Ultra High Molecular Weight Polyethylene (UHMW-PE), and can include acetal resins, such as Delrin®. These materials can be cast and machined to make the hook portion 52. Other plastic materials known in the art can be used and can be formed by casting, machining, molding, injection molding, and other techniques known in the art for forming the plastic material in to the hook portion 52.

Preferably, the hook portion 52 is composed of polycarbonate and more preferably solid, Lexan® polycarbonate. As is known, polycarbonate is a lightweight plastic used in a variety of industries. Preferably, the disclosed hook portion 52 is formed from a preformed rod of extruded polycarbonate. The rod is substantially cylindrical and can have a cylindrical, hexagonal, or square cross-section. In addition, the rod can be flattened or oval in cross-section to provide additional resting area when formed in to the hook portion 52. To form the disclosed hook portion 52, a suitable length of polycarbonate rod is heated in an industrial oven at about 320-degrees Fahrenheit. The polycarbonate rod must be heated in step fashion for a number of days to insure the quality of the polycarbonate. Once sufficiently heated, the rod is bent into its desired shape using forms and allowed to cool and harden to maintain the desired shape. Of course, other techniques for forming the disclosed hook portion can be used, such as injection molding.

In the present embodiment, the shaft portion 54 is hollow and can be composed of fiberglass, graphite, acrylic, polycarbonate, aluminum or other metal, or other strong material. The shaft portion 54 can be any desirable length. However, the shaft portion 54 is preferably about 24-inches to even 50-inches in length for use with large bodied poisonous snakes, such as Gaboon Vipers and the like. The shaft portion 54 can include extensions (not shown) for supporting the snakes at different distances from the handle.

An end (not shown) of the hook portion 52 fits within a distal end 55 of the shaft portion 54 and is attached thereto. Because the snake hook or rod 50 is used to support large bodied snakes, which can weigh up to 200-lbs. or more, the attachment at the distal end 55 of the shaft portion 54 is preferably robust. Preferably, an epoxy or glue, to attach the hook portion 52 to the shaft portion 54. However, other techniques known in the art can be used, such as a bolt and nut passing through the ends of the hook 52 and shaft 54 portions or by crimping the distal end 55 of the shaft portion 54 on the end of the hook portion 52. Additionally, the connection of the hook portion 52 to the shaft portion 54 can be covered with heat shrink, electrical tape, or some other type of tape to ensure the distal end 55 of the shaft portion 54 does not splinter. Such splinters could potentially cause injures to snakes engaged on the hook.

As best shown in FIG. 3B, the hook portion 52 is formed into the recurve from a cylindrical rod of polycarbonate as described above. The rod forming the hook portion 52 is preferably about ¼-inch to 3-inch thick in diameter 56. The jaw opening 58 can be about ½-inch up to and including 12-inches. In addition, the distal end 59 of the hook portion 52 preferably forms a blunt point 59 for initially fitting the hook under a snake when using the snake hook 50.

As discussed in the background section of the present disclosure, snake hooks in the prior art have hook portions made of aluminum, steel, and titanium, and these metal hooks are formed from metal rods having ⅜-inch diameter. Such a thin rod for the hook portion can be undesirable for use with some snakes, such as neonates or the Gaboon Viper due to their ribs. In addition, large bodied snakes weighing as much as 200-lbs. need a hook with a broad base, which the thin rod of the prior art hooks do not provide. As also noted above, the metal hooks in the prior art are also formed from flat metal, which can have a thickness of about 3/16-inch. These flat metal hooks can also be undesirable for use with some snakes, such as neonates or the Gaboon Viper due to their ribs.

In contrast, the rod forming the hook portion 52 of the present invention has a diameter of about ¼-inch to 3-inches for the hook portion 52. The diameter of the hook portion 52 as well as the length of the shaft 54 may be selected based on the size and nature of the snake to be handled. The larger diameter polycarbonate rod provides a broad base or resting area on the hook portion 52 for supporting large bodied snakes and overcomes the undesired effects of the thinner, metal hooks in the prior art on the anatomy of the snakes. The smaller diameter polycarbonate rod for the hook portion 52 is best suited for smaller neonate snakes to eliminate possible injury that metal can do to the delicate skeletal structure and skin of the newborn snakes. For example, metal hooks known in the art can puncture or crush these animals. Because newborn snakes can still be venomous, use of a hook is still beneficial. When using the disclosed polycarbonate hook portion 52 formed from a smaller diameter rod, a handler can maintain a safe distance, but the flexibility of the rod will insure the snake will not get accidentally injured. The resting area provided by the present hook is defined by both the diameter of the polycarbonate rod formed into the hook and the curvature or profile which the rod is formed into. It should be appreciated that polycarbonate provides a light means for producing a larger diameter rod. As described above, an increase in the diameter of the polycarbonate rod increases the surface area available to a snake.

As discussed in the background section of the present disclosure, snake hooks in the prior art for use with large bodied snakes have metal hook portions weighing as much as 12-lbs. These heavy metal hooks in the prior art are attached to rods having lengths as long as 24-inches or even 54-inches, for example, which further amplifies their weight to a handler using them. Any addition weight caused by the prior art snake hooks makes handling large bodied snakes more difficult. Furthermore, when handling large bodied snakes and especially poisonous snakes, a handler may use two snake hooks with one in each hand. Thus, the heavy metal hooks in the prior art also make handling a snake with two hooks by a handler more difficult.

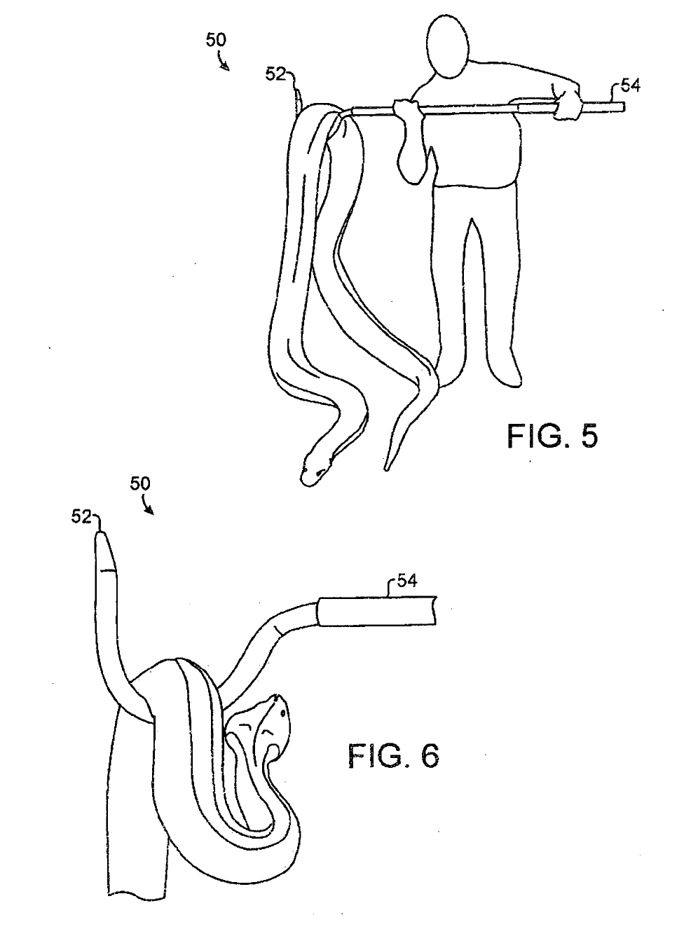

In contrast, the disclosed hook portion 52 composed of polycarbonate or another material having similar characteristics is lightweight and can weigh about 2-lbs. or less depending on its size. Such a lightweight hook portion 52 does not add substantial weight and allows a handler to easily use one or more of the snake hooks 50. Thus, the polycarbonate hook portion 52 has a minimal weight but is very strong. FIG. 5 shows a handler with the disclosed snake hook 50 moving a large python.

In addition, the disclosed hook portion 52 is beneficial for use with Gaboon Vipers as opposed to the metal hooks with small diameters of the prior art that get between the Viper's ribs and break them. Because of the venomousness of the Gaboon Viper as well as its 2-inch fangs, the disclosed hook portion 52 can be especially useful because the disclosed hook portion 52 is lightweight and enables handlers to move the snake at a distance without endangering the snake. Because the resting area is greater on the disclosed hook portion 52, the Viper will be more relaxed and comfortable on the hook 52.

For example, if a Viper is uncomfortable on a thin, metal hook of the prior art, the snake will attempt to gain a more comfortable position and move itself from the uncomfortable hook onto the shaft. By contrast, FIG. 6 shows a Gaboon Viper resting on the disclosed hook portion 52 of the snake hook 50. Instead of attempting to gain a more comfortable position on the shaft portion 54, the snake is resting on the thicker hook portion 52 and merely eyeing the handler, who is at a distance and not shown. Furthermore, metal hooks of the prior art can cause snakes to react by attempting to jump off of the hook or to move about on the hook because the metal “feels cold” to the snake. Metal hooks have higher thermal conductivities, and may be stored and used indoors where the ambient temperature is lower than a snake's body temperature. Therefore, as the snake sits on a metal hook heat is transferred from the snake to the hook at a faster rate. This heat transfer results in the “cold feeling” of the metal. As cold-blooded creatures, snakes are drawn to warmth, such as heat rocks and naturally tend to vacate the cold metal hook. The snake looses body heat to the metal hook quickly and becomes uncomfortable after a very short period of time. In contrast, snakes are acclimated to, if not attracted to, the hook of the present invention, with a much lower thermal conductivity. The disclosed hook portion 52 composed of the polycarbonate or the like transfers heat off the snake at a much slower rate, i.e. a rate similar to that of a tree branch, and feels more natural for the snake. This natural feel can induce the snake to coil or wrap around the hook as opposed to jumping off the hook or sliding up the shaft of the hook.

It should be appreciated embodiments of the present invention envision snake hooks of various sizes and shafts of various lengths. Those familiar with handling snakes could select the appropriate hook to handle a snake of a particular length and weight. It is further envisioned different hooks could be formed with various profiles. That is, hooks roughly the same in size could be formed in slightly different shapes to accommodate different snakes. For example, while two hooks may be of roughly the same size, one may have a larger resting area than the other in order to accommodate wider bodied snakes.

It should further be appreciated, the present hook can be used to handle a number of reptiles, including, but not limited to, smaller komodo dragons, alligators, and crocodiles. The present hook increases the safety of these reptiles because they are less likely to shatter teeth or fangs if and when they strike at the hook.

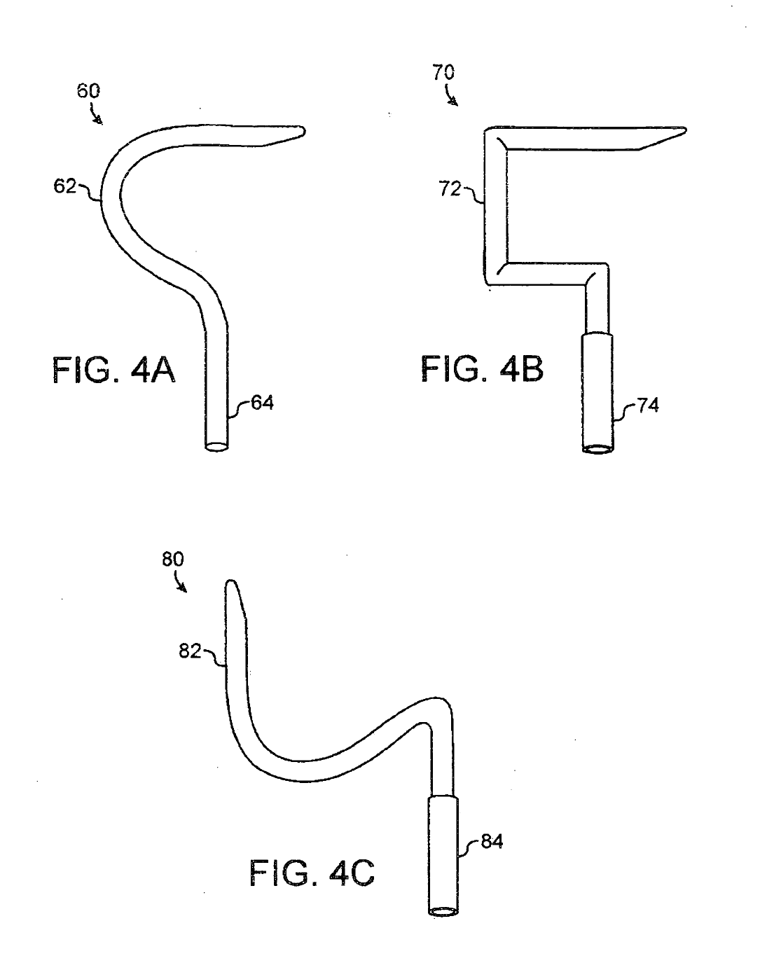

Referring to FIGS. 4A-4B, various embodiments of the disclosed snake hook are illustrated, including several different configurations for the resting area of the snake hook. The resting area is considered to the portion of the hook the body of the snake will rest against as the snake is engaged. In FIG. 4A, the snake hook 60 includes a hook portion 62 integrally formed with a shaft portion 64, which is only partially shown. In this embodiment, both the hook and shaft portions 62 and 64 are composed of polycarbonate. This snake hook 60 may be best suited for handling smaller neonates because of flexibility.

In FIG. 4B, the snake hook 70 includes a hook portion 72 attached to a shaft 74, which is only partially shown. The hook portion 72 has an alternative profile than the previous embodiments with the recurve profile. The hook portion 72 has a generally rectilinear profile and is suitable for use in corners of a cage. This profile for the resting area also provides a flatter resting area for a snake, which maybe preferable. In FIG. 4C, the snake hook 80 includes a hook portion 82 on a shaft portion 84. The hook portion 82 has an S-profile, which is suitable for extracting snakes from trees from otherwise elevated positions, while providing a suitable rest area.

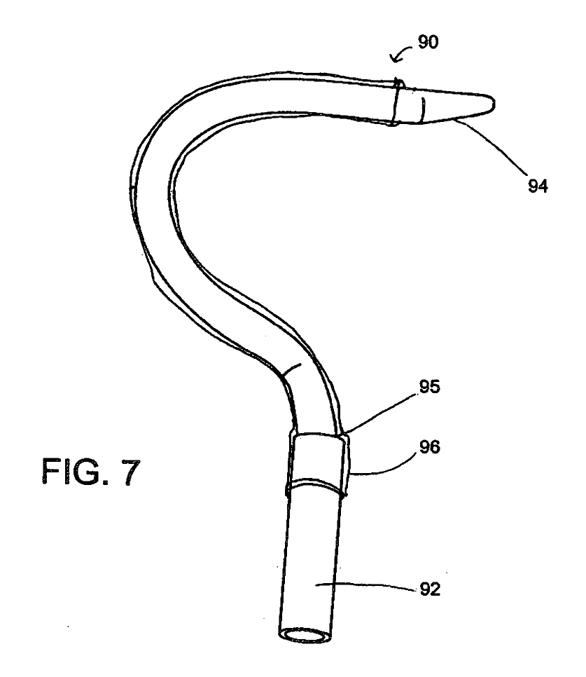

FIG. 7 illustrates an alternative embodiment of the snake hook 90, comprising a hook 94 mounted on a shaft 92, much like the first embodiment. The hook 94 can be constructed from any material. In order to provide a surface that avoids the cold “feel” of metal hooks, the hook 94, or a portion of the hook that engages a snake, is wrapped, covered or coated in an insulating material 96. In FIG. 5 the insulating material 96 can be see covering the distal end of the shaft 95. This overlap onto the shaft can serve as the same safety feature to snakes and other reptiles whether or not the insulating material only covers a small area as long as the insulating material covers the end. By way of a non-limiting example, heat shrink material could be placed around the end portion of the shaft and run the entire distance of the hook. The present application envisions a hook, such as a metal hook, could be covered in a plastic or rubber material. This configuration does not provided the advantage previously discussed with respect to the devices weight, but it does provide a surface with a lower co-efficient of thermal conductivity and this males cold-blooded reptiles, such as snakes, less likely to maneuver off the hook or up the shaft of the device towards a user.

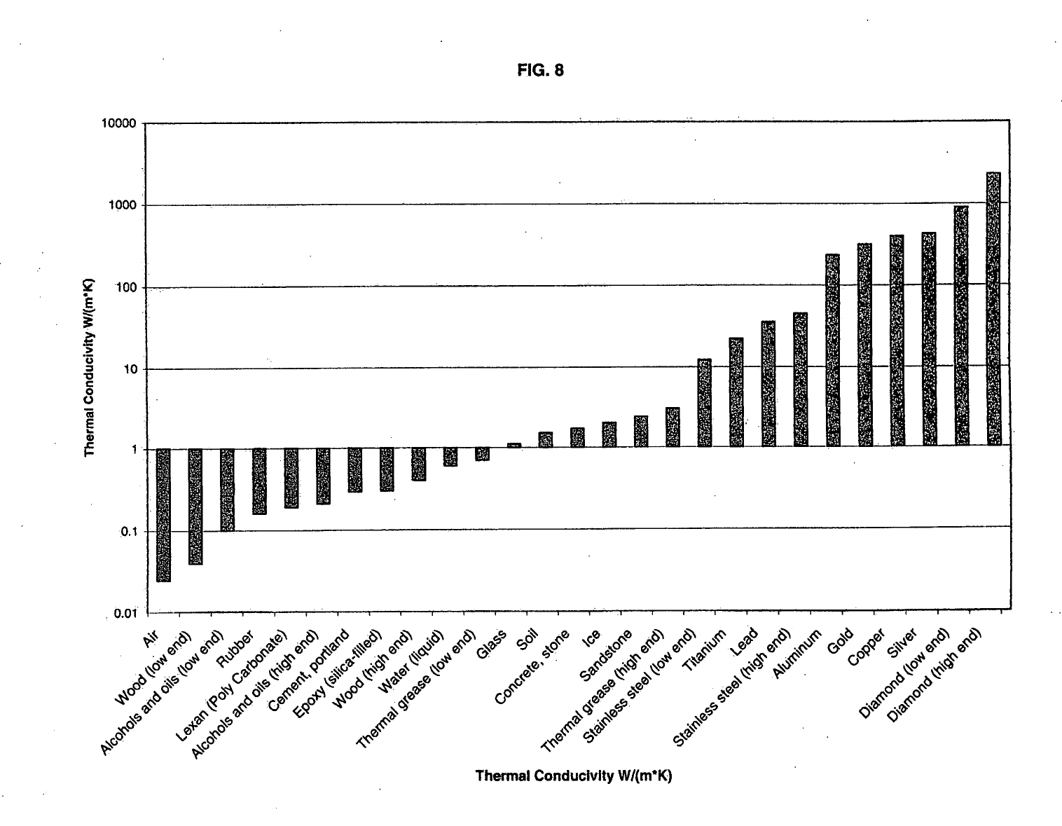

FIG. 8 illustrates a graph representing a number of materials and their values of thermal conductivity in Watts per meter Kelvin (W/(m*K)). The values are plotted against a logarithmic axis. It can be seen, materials such epoxy, wood, and rubber have values of less than about 1 (W/(m*K)), while steel ranges from about 12-45 (W/(m*K)), and still other metal such as copper, silver and gold are well over 100 (W/(m*K)). At 23 degrees Celsius, polycarbonate ranges from about 0.19-0.22 (W/(m*K)). This range for Polycarbonate resides within the range of thermal conductivity indicated for wood, which ranges from 0.04 to 0.4 (W/(m*K)). In one embodiment of the present invention, the portion of a hook that actually contacts a snake or reptile would have a thermal conductivity under about 4 (W/(m*K)), and preferably under about 1 (W/(m*K)). Table 1 set forth below, provides the values for each material found in FIG. 8.

TABLE 1

| Material | W/(m · K) |
|---|---|
| Air | 0.025 |
| Wood (low end) | 0.04 |
| Alcohols and oils (low end) | 0.1 |
| Rubber | 0.16 |
| Lexan (Polycarbonate) | 0.20 |
| Alcohols and oils (high end) | 0.21 |
| Cement, portland | 0.29 |
| Epoxy (silica-filled) | 0.3 |
| Wood (high end) | 0.4 |
| Water (liquid) | 0.6 |
| Thermal grease (low end) | 0.7 |
| Glass | 1.1 |
| Soil | 1.5 |
| Concrete, stone | 1.7 |
| Ice | 2 |
| Sandstone | 2.4 |
| Thermal grease (high end) | 3 |
| Stainless steel (low end) | 12.11 |
| Lead | 35.3 |
| Stainless steel (high end) | 45 |
| Aluminum | 237 |
| Gold | 318 |
| Copper | 401 |
| Silver | 429 |
| Diamond (low end) | 900 |
| Diamond (high end) | 2320 |

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A device for handling a snake with increased safety to a handler and increased comfort to the snake comprising:
a shaft mounted with a polycarbonate rod shaped into a hook, wherein the hook shape of the polycarbonate rod is formed into a profile substantially congruent with the snake.

2. The device according to claim 1 wherein the polycarbonate rod is inserted into a hollow distal end of the shaft.

3. The device according to claim 2 wherein heat shrink material is secured around the connection of the shaft and the hook.

4. The device according to claim 1 wherein the distal end of the polycarbonate rod is tapered to a flat surface or a point.

5. The device according to claim 1 wherein the polycarbonate rod further comprises a first portion generally parallel to the shaft and a second portion generally perpendicular to the shaft, wherein the second portion of the shaft contains a distal end which is tapered to at least one of a flat surface and a point.

6. The device according to claim 5 wherein an outer surface of the second portion facing away from the shaft at the taper generally retains shape and an inner surface of the second portion facing towards the shaft flattens to form the taper.

7. The device according to claim 1 wherein the cross section of the polycarbonate rod is circular with a diameter greater than 0.5-inches diameter and weighs less than 2 lbs.

8. The device according to claim 1 wherein the polycarbonate rod is formed into a rectilinear hook profile.

9. A device for handling reptiles comprising:
a shaft with an axis, the shaft comprising a first end and a second end;
a polycarbonate rod formed in the shape of a hook mounted with the first end of the shaft;
a handle mounted at the second end of the shaft;
wherein the distal end of the polycarbonate rod is tapered to a flat surface or to a point and wherein the shape of the hooked formed from the polycarbonate rod is configured in a profile for handling a reptile.

10. The device according to claim 9 wherein the connection of the polycarbonate hook and the shaft is covered with heat shrink material at the first end.

11. The device according to claim 9 wherein the hook further comprises a first portion generally parallel to the shaft and a second portion generally perpendicular to the shaft, and wherein the second portion of the shaft contains a distal end which is tapered to a flat surface or to a point.

12. The device according to claim 11 wherein an outer surface of the second portion facing away from the shaft at the taper generally retains shape and an inner surface of the second portion facing towards the shaft flattens to form the tapered end.

13. A device for handling a snake with increased safety to a handler and increased comfort to the snake comprising:
a shaft comprising a hook at a distal end thereof, wherein the hook is formed into a profile substantially similar to a snake and at least a portion of the outer surface of the hook has a thermal conductivity less than about 4 W/(m·K).

14. The device according to claim 13 further comprising a heat shrink material secured around the hook.

15. The device according to claim 13 wherein the distal end of the hook is tapered to a flat surface or a point.

16. The device according to claim 13 wherein the hook further comprises a first portion generally parallel to the shaft and a second portion generally perpendicular to the shaft, wherein the second portion of the hook contains a distal end which is tapered to a flat surface or to a point.

17. The device according to claim 16 wherein an outer surface of the second portion facing away from the shaft at the taper generally retains shape and an inner surface of the second portion facing towards the shaft flattens to form the tapered end.

18. The device according to claim 13, wherein at least a portion of the hook is formed from a material having thermal conductivity less than about 4 W/(m·K).

19. The device according to claim 15 wherein at least a portion of the hook is covered or coated or wrapped in a material having thermal conductivity of less than about 4 W/(m·K).

20. A method of handling a snake including the steps of:
selecting a device having a surface substantially congruent with the surface of the snake
adapting the device to have a portion with a thermal conductivity less than about 4 W/(m·K);
engaging the snake with the portion of the device with a thermal conductivity less than about 4 W/(m·K);
manipulating the device to transport the snake form a first location to a second location;
disengaging the snake from the device.

21. The method according to claim 20 wherein the step of selecting a device having a surface for contacting the snake with a thermal conductivity less than about 4 W/(m·K) further comprises: selecting a device having a surface for contacting the snake with a thermal conductivity less than about 1 W/(m·K).
